(19) United States
(12) Patent Application Publication
(10) Pub. No.: US 2010/0279208 A1
(43) Pub. Date: Nov. 4, 2010

(54) FUEL CELL AND BIOPOLAR PLATE FOR LIMITING LEAKAGE

(76) Inventors: David A. Niezelski, Manchester, CT (US); John H. Whiton, South Windsor, CT (US); Richard R. Phillips, West Hartford, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/810,036

(22) PCT Filed: Dec. 26, 2007
(86) PCT No.: PCT/US07/88796

§ 371 Date: Jun. 22, 2010

(51) Int. Cl. H01M 8/02

(52) U.S. Cl. 429/514

(57) ABSTRACT

A device for use in a fuel cell includes a bipolar plate having a region encompassing a flow field, and at least one channel that is located outside of the region for conveying a seal fluid to limit leakage of a reactant gas from a fuel cell.

### BACKGROUND OF THE DISCLOSURE

This disclosure relates to fuel cells. More particularly, this disclosure relates to limiting leakage of reactant gases from the fuel cell.

Fuel cells are widely known and used for generating electricity for a variety of uses. Typically, a fuel cell unit includes an anode, a cathode, and an ion-conducting polymer exchange membrane (PEM) between the anode and the cathode. The anode and cathode are between bipolar plates (also referred to as separator plates) that include flow fields for delivering reactant gases to the PEM for generating electricity in a known electrochemical reaction. Typically, one or more of the bipolar plates also include a coolant flow field on an opposing side that circulates water to maintain the fuel cell unit at a desirable operating temperature.

One problem associated with fuel cells relates to containing the reactants within the fuel cell to limit or prevent overboard leakage. For example, in a fuel cell that utilizes porous bipolar plates, sometimes referred to as water transport plates, the reactant gases are typically supplied at desirable gas pressures relative to a pressure of the coolant water. However, if the pressures are not maintained within a desirable range, the reactant gases may overcome the coolant water pressure and escape from the flow fields. Additionally, for porous or solid bipolar plates, the reactant gases may also diffuse through the materials used to make the fuel cell or may escape through leak paths formed between the bipolar plates and the PEM. Thus, in systems where leakage avoidance is important, it is generally desirable to provide a containment strategy to prevent or limit overboard leakage of the reactant gases.

One example fuel cell for containing leakage of reactant gases is disclosed in U.S. Pat. No. 6,187,466 issued to Schroll et al., which includes a wet edge seal to limit leakage. The wet edge seal is formed near the sides of porous water transport plates. Capillary forces associated with the size of the pores cause water to impregnate the pores. The impregnated pores provide a wet seal that limits reactant gas leakage into the water coolant system and overboard leakage of the reactant gases.

The wet seal may have several problems that would lead to leaking For example, the small size of the pores and the relatively low flow of water through the pores may not be adequate to contain all types of leaks. A relatively large leak or a constant leak may overcome the containment capacity of the wet seal. Furthermore, some porous water transport plates are known to be vulnerable to “dry out” because of a difficulty in transporting water through the pores to maintain all portions of the plate in a wet state. If dry-out occurs at the wet seal, the dry portions may provide a leakage path through the wet seal.

Accordingly, there is a need for a fuel cell and bipolar plate for limiting leakage of reactant gases from the fuel cell.

### SUMMARY OF THE DISCLOSURE

An example device for use in a fuel cell includes a bipolar plate having a region encompassing a flow field. At least one channel is located outside of the region for conveying a seal fluid to limit leakage of a reactant gas from a fuel cell. In one example, a plurality of the bipolar plates is associated with at least one electrode for generating electricity in a known manner.

An example method of controlling overboard leakage includes establishing a flow of the seal fluid through the channel and capturing the reactant gas that has leaked from the region with the seal fluid to thereby limit overboard leakage of the reactant gas from the fuel cell.

### BRIEF DESCRIPTION OF THE DRAWINGS

The various features and advantages of this disclosure will become apparent to those skilled in the art from the following detailed description of the currently preferred embodiment. The drawings that accompany the detailed description can be briefly described as follows.

FIG. 1 illustrates an example fuel cell having at least one unitized cell assembly.

FIG. 2 illustrates a bipolar plate of the fuel cell.

FIG. 3 illustrates one side of another bipolar plate of the fuel cell.

FIG. 4 illustrates the other side of the bipolar plate of FIG. 3.

FIG. 5 illustrates a selected portion of a unitized cell assembly of the fuel cell.

### DETAILED DESCRIPTION OF THE PREFERRED EMBODIMENT

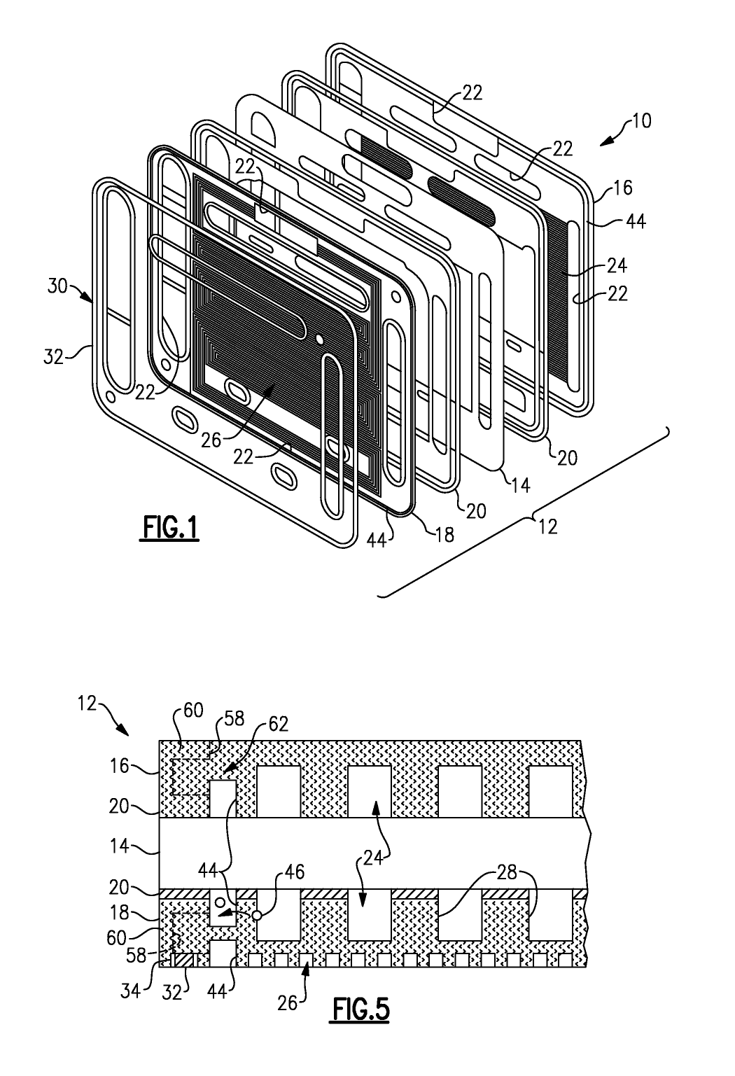

FIG. 1 schematically illustrates an exploded view of selected portions of an example fuel cell 10 for generating electricity. In the illustrated example, the fuel cell 10 includes at least one unitized cell 12. For example, a plurality of the unitized cells 12 may be used to form a fuel cell stack, depending on the desired amount of electricity to be generated. As is known, the unitized cell 12, or alternatively a fuel cell stack having multiple unitized cells 12, may be secured between pressure plates in a known manner to form the fuel cell 10. Furthermore, the fuel cell 10 may include various additional components that are not illustrated, such as components associated with the supply of reactant gases, coolant water, etc. Given this description, one of ordinary skill in the art would recognize that the disclosed examples are applicable to a variety of different fuel cell configurations.

In the disclosed example, the unitized cell 12 includes a membrane electrode assembly (MEA) 14 located between a first bipolar plate 16 and a second bipolar plate 18, which may be referred to as anode and cathode bipolar plates depending on the location relative to the MEA 14 electrodes. The bipolar plates 16 and 18 may be porous, as in the illustrated example, or solid, for example carbon composite or metallic. For example, the MEA 14 includes a cathode catalyst electrode, an anode catalyst electrode, and a polymer exchange membrane, but is not limited to any specific configuration.

In the illustrated example, the first bipolar plate 16, the second bipolar plate 18, and the MEA 14 are secured together using, for example, bonding films 20. For example, the bonding film 20 is a relatively thin layer of low density polyethylene.

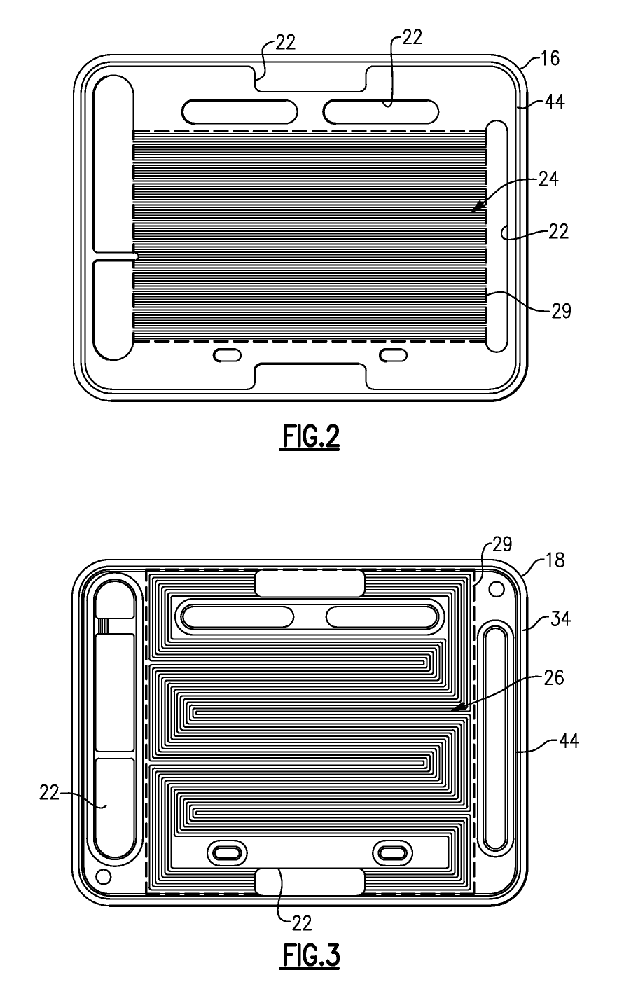

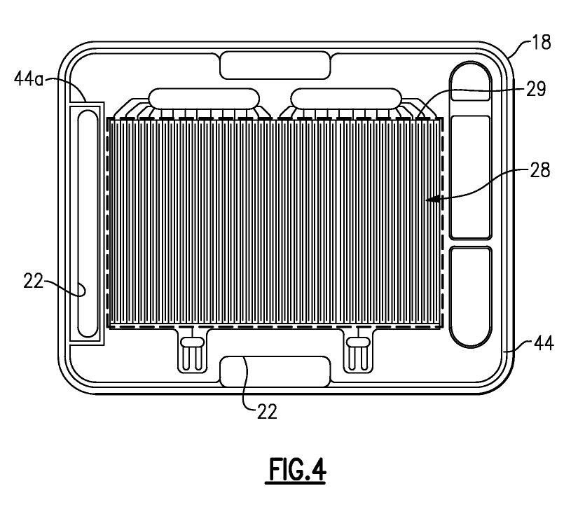

The first bipolar plate 16 is also shown in FIG. 2. The second bipolar plate 18 is also shown in FIG. 3, and the other side of the second bipolar plate 18 that is not visible in FIGS. 1 and 3 is shown in FIG. 4. The reverse side of the first bipolar plate 16 may also be configured similarly to that shown in FIG. 4. The bipolar plates 16 and 18 each include a variety of different manifolds 22 and flow fields 24. Referring also to FIG. 5, the flow field 24 of the first bipolar plate 16 in the disclosed example supplies a first reactant gas (e.g., hydrogen) to the MEA 14. The flow field 24 of the second bipolar plate 18 in the disclosed example includes two different types of flow fields 24. A first flow field 26 on one side circulates coolant water and another flow field 28 on the other side supplies a second reactant gas (e.g., oxygen) to the MEA 14. The manifolds 22 supply either coolant water or reactant gases to the flow fields 24, 26, 28 in a known manner.

Each of the flow fields 24, 26, and 28 defines an associated region 29 (represented with dashed lines) that encompasses the respective flow field 24, 26, or 28. Thus, each region 29 defines areas that are inside of the region 29 (e.g., the flow fields 24, 26, or 28) and areas that are outside of the region 29, such as the manifolds 22.

In the illustrated example, the unitized cell 12 utilizes a gasket system 30 to seal the unitized cell 12 and prevent intermixing of the reactant gases and coolant water. For example, the gasket system 30 includes one or more gaskets 32 located within gasket channels 34 that extend about the perimeter of the second bipolar plate 18 and about the various manifolds 22. In other examples, additional gaskets may be used depending on the particular configuration of the fuel cell 10.

Each of the example bipolar plates 16 and 18 includes a channel 44 that is located outside of the region 29 of the respective bipolar plate 16 or 18. In the disclosed example, the channels 44 completely circumscribe the regions 29 of the flow fields 24, 26, and 28, although in other examples the channels 44 may extend only partially about the flow fields 24, 26, 28.

The channels 44 circulate a seal fluid that limits leakage of the reactant gas from the fuel cell 10. In the illustrated example, the channels 44 are formed into the corresponding bipolar plates 16 and 18. For example, the channels 44 may be formed in a similar manner as channels of the flow fields 24, 26, and 28, such as by machining, molding, or other suitable method.

In the illustrated example, the channel 44 of the first bipolar plate 16 extends about the periphery and is fluidly connected with at least one of the manifolds 22 that supplies coolant water. The second bipolar plate 18 includes two of the channels 44, one on each side. The channels 44 of the second bipolar plate 18 are also fluidly connected with one of the manifolds 22 that supplies coolant water. Optionally, any of the channels 44 may also include one or more branch channels, such as branch channel 44a (FIG. 4), that extend from the channel 44 adjacent to one or more of the manifolds 22. In the illustrated example, the branch channel 44a circumscribes one of the manifolds 22, such as a fuel reactant gas exit manifold, to limit any leakage therefrom as will be described more fully below. Additionally, the first bipolar plate 16 may also include a second one of the channels 44, similar to the second bipolar plate 18.

In operation, the coolant water from the manifolds 22 flows through the second flow field 26 of the second bipolar plate 18 to provide cooling. If porous types of the bipolar plates 16 and 18 are used, the coolant water also maintains the bipolar plates 16 and 18 in a wet state by infiltrating the pores.

The coolant water also flows through the channels 44 and serves as a seal fluid. Any reactant gas that leaks from the flow fields 24 may be captured and carried away by the coolant water flowing through the channels 44 to thereby prevent or limit overboard leakage from the fuel cell 10, as will be discussed more fully below.

In the disclosed example, the channels 44 of each bipolar plate 16 and 18 are located between the gasket channels 34 and the each of the regions 29. Thus, the coolant water flowing within the channels 44 provides a first stage of leak prevention, and the gaskets 32 provide a second stage of leak protection if any reactant gas does penetrate through the coolant water and channels 44. Alternatively, the gaskets 32 may be located between the channels 44 and the regions 29.

In one example, the first bipolar plate 16, the second bipolar plate 18, or both are porous such that the coolant water infiltrates the pores in a known manner. However, under certain circumstances, the pores may dry out and thereby provide a leakage path for the reactant gases. For example, a bubble 46 may diffuse through a dry portion of the second bipolar plate 18, as illustrated in FIG. 5. As the bubble 46 diffuses toward the edge of the unitized cell 12, it encounters one of the channels 44. The coolant water flowing through the channel 44 captures the bubble 46 and thereby prevents it from leaking overboard from the fuel cell 10. Likewise, if a leakage path is formed interfacially between the first bipolar plate 16 or the second bipolar plate 18 and the bonding films 20, any leaked reactant gas may be captured by the coolant water flowing through the channels 44 to prevent the reactant gas from leaking overboard.

Additionally, the pressure of the coolant water for the channels 44 may be controlled relative to a pressure of the reactant gases to facilitate capture of leaked reactant gas. For example, the reactant gas pressure may be higher than the coolant water pressure such that a pressure differential therebetween draws any leaked reactant gas into the channels 44. Depending on the magnitude of the pressure differential, there may be a zone of influence that extends several channel widths from the channel 44 to draw in any leaked reactant gas from the regions 29 or manifolds 22.

In the disclosed example, a mass flow of the coolant water through the channels 44 may be controlled to provide a desired amount of protection against leaking. For example, a relatively greater mass flow provides the ability to carry away a corresponding greater amount of leaking reactant gas. Thus, a desired mass flow of the coolant water can be established based on an expected amount of reactant gas leakage to provide a desired degree of overboard leakage protection. In one example, the flow of the coolant water through the channels 44 is controlled in a known manner, such as by using a pump that is associated with circulating the coolant water.

Optionally, as shown in FIG. 5, the edges of the first bipolar plate 16, the second bipolar plate 18, or both may include an edge seal 58 to further limit leakage. In this example, the edge seals 58 include a solid sealant material 60 impregnated within the pores of the first bipolar plate 16 or the second bipolar plate 18. For example, the solid sealant material 60 includes low-density polyethylene or other type of sealant material.

In the disclosed example, the edge seal 58 forms a U-shape that encapsulates a volume of pores that do not contain the solid sealant. In other examples, the edge seals 58 may have different configurations. The encapsulated volume of pores and the pores within a transition section 62 near the opening of the U-shape may be vulnerable to dry out because the solid sealant material 60 limits accessibility of the coolant water. Additionally, hydrophobicity of the solid sealant material 60 may impede coolant water transport into the pores near the edge seal 58. However, in the illustrated example, the channels 44 are located immediately adjacent the edge seals 58 and thereby provide a source of coolant water to maintain the pores near the edge seal 58 in a wet state. Thus, the channels 44 also provide the benefit of limiting dry out of the bipolar plates 16 and 18.

Additionally, the channels 44 may be located near one of the manifolds 22 that functions as an inlet for oxygen reactant gas. In this regard, the coolant water from the channel 44 may also function to hydrate the reactant gas to a desired degree as the reactant gas enters the fuel cell 10.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments. For example, although the illustrated embodiment conveniently utilizes the existing coolant water from the coolant manifold as the seal fluid which flows in channel 44, it is also possible for the seal fluid to be a gas, such as nitrogen, or a separate other fluid, such as antifreeze. In such instance, the seal fluid may be operated independently of other fluid systems in the fuel cell or as in the illustrated example, may be integrated with the fuel cell system.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A device for use in a fuel cell, comprising:
a bipolar plate including a region encompassing a flow field; and
at least one channel that is located outside of the region for conveying a seal fluid to limit leakage of a reactant gas from a fuel cell.

2. The device as recited in claim 1, wherein the flow field comprises a coolant flow field.

3. The device as recited in claim 1, wherein the flow field comprises a reactant gas flow field.

4. The device as recited in claim 1, wherein the at least one channel comprises a first channel on a first side of the bipolar plate and a second channel on a second, opposite side of the bipolar plate.

5. The device as recited in claim 1, wherein the at least one channel extends at least partially into the bipolar plate.

6. The device as recited in claim 1, wherein the at least one channel circumscribes the region.

7. The device as recited in claim 1, wherein the at least one channel comprises a rectangular cross-section.

8. The device as recited in claim 1, wherein the bipolar plate includes a gasket extending partially about the region, and the at least one channel is located between the gasket and the region.

9. The device as recited in claim 1, wherein the bipolar plate comprises a porous structure.

10. The device as recited in claim 1, wherein the bipolar plate comprises a sealed edge section having pores that are at least partially filled with a solid sealant.

11. The device as recited in claim 10, wherein the bipolar plate includes a transition section between the sealed edge section and a remaining portion of the bipolar plate, wherein the at least one channel is immediately adjacent the transition section.

12. The device as recited in claim 1, wherein the bipolar plate includes a manifold, and the at least one channel circumscribes the manifold.

13. The device as recited in claim 12, wherein the manifold comprises at least one of a coolant manifold or a reactant gas manifold.

14. The device as recited in claim 1, further including a gasket extending partially about the region.

15. A fuel cell comprising:
at least one electrode;
a plurality of bipolar plates associated with the at least one electrode, each of the bipolar plates including a region encompassing a flow field; and
a channel that is located outside of the region for conveying a seal fluid to limit leakage of a reactant gas from a fuel cell.

16. The fuel cell as recited in claim 15, wherein the bipolar plates each include a coolant manifold for supplying coolant to the bipolar plates, and the channel is fluidly connected with the coolant manifold.

17. The fuel cell as recited in claim 16, wherein each coolant manifold includes a first manifold near one end of the corresponding bipolar plate and a second manifold section near another end of the corresponding bipolar plate.

18. The fuel cell as recited in claim 15, wherein the flow fields comprise at least one of a coolant flow field or a reactant flow field.

19. The fuel cell as recited in claim 15, wherein the at least one electrode comprises an anode catalyst, a cathode catalyst, and a polymer exchange membrane.

20. A method of controlling overboard leakage of a reactant gas from a fuel cell that includes a plurality of bipolar plates that each include a region encompassing a flow field and a channel that extends at least partially about the flow field, comprising:
establishing a flow of a seal fluid through the channel; and
capturing a reactant gas that has leaked from one of the regions with the seal fluid to thereby limit overboard leakage of the reactant gas from the fuel cell.

21. The method as recited in claim 20, further including establishing a desired flow of the seal fluid based upon an expected reactant gas leak rate.

22. The method as recited in claim 20, further including establishing the flow of the seal fluid from a coolant manifold of the plurality of bipolar plates that supplies a coolant.

23. The method as recited in claim 20, establishing the flow of the seal fluid at a location that is between one of the flow fields and a gasket that extends about a periphery of one of the bipolar plates.

24. The method as recited in claim 20, establishing a first pressure of the seal fluid and a second pressure of the reactant gas that is greater than the first pressure to draw the reactant gas that has leaked from the region into the seal fluid.
